(19) United States
(12) Patent Application Publication
(10) Pub. No.: US 2012/0066888 A1
(43) Pub. Date: Mar. 22, 2012

(54) METHOD FOR JOINING TWO COMPONENTS OF A UNIT

(75) Inventor: Horst Wisniewski, Aalen (DE)

(73) Assignee: Alfing Kessler Sondermaschinen GmbH, Aalen (DE)

(21) Appl. No.: 13/257,043

(22) PCT Filed: Mar. 16, 2009
(86) PCT No.: PCT/EP2009/053063

§ 371 Date: Nov. 22, 2011

(51) Int. Cl. B23P 11/00; B25B 27/14

(52) U.S. Cl. 29/525.11; 29/281.1

(57) ABSTRACT

The invention relates to a method for joining two components (10, 12) of a unit (1), especially a fractured unit, to be screwed together. Said method comprises the following steps: the components are first joined by a joining device (2), especially a joining press (22), the components are separated, and the components are then rejoined by being screwed together.

### TECHNICAL DOMAIN

The present application relates to a method for joining two components of a unit, especially a fractured unit, in particular a broken connecting rod or a fractured universal joint yoke, to be screwed together, as well as to a joining system for implementing the method.

### BACKGROUND TO THE INVENTION

When joining components of units to be screwed together it is often necessary to assist fixing procedures within the joint surface by the two components of the unit to be joined being brought into contact with one another on the joint surface under a specific surface pressure.

In the region of the fractured units, in particular in the region of fractured connecting rods and fractured universal joint yokes, these fixing procedures are typically initiated by the fractured unit being screwed together once with the screws provided for this purpose, the screws then being loosened again, and the two components of the unit being moved apart from one another in order to remove any foreign bodies, such as for example particles or other impurities, which have been detached by the fixing procedure. Then the two components are screwed together by the screws for a second time so that the fractured unit can be brought into its final fitted position.

After opening the two components of the fractured unit, the joint surface, in particular the separation surface, is cleansed of the detached foreign bodies, in particular particles, inclusions or other impurities, by shaking, brushing, blowing off, fluid treatment or other mechanical procedures. The effect of this, among other things, is that when re-opened in order to fit the fractured unit in its final fitted position, particles, which are located on the separation surface, cannot pass into the respective fitting space, such as the inside of an engine.

The fixing procedures in the joining surface, in fractured units especially in the separation surface, take place with every re-screwing and correspondingly every re-pressing together of the separation surfaces in the separation surface/joining surface. The fixing procedures are also dependent upon the respective joining force or surface pressure with which the separation surfaces are pressed onto one another.

The screws, which typically with broken connecting rods are used to connect the two components to one another again, i.e. to connect the top back onto the shaft, can normally only be screwed three times to the yield point, and then they are unusable. Accordingly, by screwing the top for the first time onto the shaft in order to initiate the fixing procedures, the subsequent opening and the repeated screwing of the top onto the shaft, two screwing procedures are already implemented. Therefore, the actual fitting procedure, for example fitting the broken connecting rod onto the crank shaft of an engine, constitutes the last possible screwing procedure for the used screws of the respective broken connecting rod. For further screwing procedures the screws would have to be changed.

### DESCRIPTION

Proceeding from the known method, it is an object of the present invention to specify a more efficient method for joining two components of a unit to be screwed together, in particular a fractured unit, wherein the fixing procedures are positively influenced in the joint surface/separation surface, and by means of which the life of the screws can be extended.

This type of method for joining two components of a unit, in particular of a fractured unit, to be screwed together comprises the steps of joining the components by means of a joining device, especially a joining press, separating the components and re-joining the components by screwing them together.

In this way, with the joining device, especially the joining press, a fixing procedure can first of all be initiated on the joining surface or the separation surface of the two components of the unit, by means of which the fixing of the respective joining surfaces can be achieved efficiently. In particular, by using the joining device, especially the joining press, it can also be avoided that the screws which are used for finally screwing together the two components of the unit, already have to be used in the first joining procedure which mainly serves to initiate the fixing procedures in the joining surface. Accordingly, the life of the screws can be extended because the first joining procedure is implemented by the joining device, and not by screwing together.

Advantageously, the two components of the unit are pressed against one another in the joining device, especially the joining press, on the joining surface with a joining force or surface pressure which is greater than the joining force or surface pressure which could be achieved simply by screwing together. In this way the fixing procedures in the joining surfaces or the separation surfaces of the two components of the unit can be accelerated.

Advantageously, the joining force can be varied during the first joining, and in particular can follow a pre-specified force characteristic curve which assists the fixing of the respective joining surfaces or separation surfaces.

In particular, it is also conceivable for the two components to be shaken against one another so as in this way to also assist detachment of any foreign bodies, especially particles, inclusions or other impurities, present between the two joining surfaces. Upon separating the two components, these then detached foreign bodies, in particular the particles, inclusions or other impurities, can be removed from the joining surfaces/separation surfaces, for example by shaking, brushing, blowing off, fluid treatment or other mechanical possibilities for removing the respective foreign bodies.

The method is advantageously used to join two components to be screwed together of a broken connecting rod, i.e. in particular the top and the shaft of the broken connecting rod, or two components of a broken universal joint yoke, i.e. in particular a top and a lower part of the universal joint yoke. The method can be used particularly well and efficiently with fractured units with which fixing of the respective separation surfaces before the actual fitting is desired and required, and with which particles, inclusions, impurities and other foreign bodies which have reached the respective separation surfaces when fractured or have remained on the latter, can be removed so that with later opening and final closure of the fractured units in the fitting position there are no problems associated with contamination in the vicinity of the fitting.

One advantageously uses as a joining device a joining press, in particular a hydraulic press, a pneumatic press and/or a press provided with a linear drive or spindle drive in which the two components of the unit to be screwed together can be accommodated,

In the method described here one can in particular not consider as a joining device a device which joins the two components of the unit to be screwed together on the latter's regular screw connection. The joining device according to the method is rather a device separate from the actual screwing device which achieves application of the joining force by means of mechanisms which do not affect the screwing together of the two components.

According to the method, it is accordingly only later that joining by screwing together takes place, namely only after the two components have initially been joined in the joining device.

In one preferred embodiment, while joining the components a joining force/path characteristic curve is recorded which is compared to a pre-specified family of reference characteristics in order to find out whether there are foreign bodies, in particular particles, inclusions or other impurities on the joining surface/separation surface between the two components. If the joining force/path characteristic curve, which was measured during the first joining procedure in the joining device, deviates from the family of reference characteristics, one can assume that there is a foreign body on the separation surface. Here, the family of reference characteristics forms the joining force/path characteristic curve of an absolutely clean joining surface/separation surface of the same unit type.

Accordingly, when separating the components careful intermediate treatment by shaking, brushing, blowing off, fluid treatment or other mechanical measures must be achieved in order to remove the foreign body. In order to check, the joining procedure can be checked once again with the joining device, in turn by recording the joining force/path characteristic curve.

Advantageously, the path, i.e. the joining path, is measured here relative to the separation surface in order to have a fixed reference point here.

Advantageously, there is specified as a solution to the object a joining system for implementing the method which comprises a joining device, especially a joining press, for applying a joining force to the components, and furthermore a device for separating the components and a device for screwing together the components.

The joining device, especially the joining press, and the device for separating the components can be integrated with one another, and for this purpose in particular a hydraulic cylinder, a pneumatic cylinder, a linear drive, a spindle drive or some other appropriate device can be chosen which can move the components both towards one another and away from one another.

### BRIEF DESCRIPTION OF THE DRAWINGS

In the following, exemplary devices for implementing the method are described by means of the attached drawings.

These show:

FIG. 1 diagrammatically, a joining device in the form of a joining press for joining two components of a broken connecting rod to be screwed together;

FIG. 2 diagrammatically, a screwing device for joining the two components of the broken connecting rod by screwing together.

### DETAILED DESCRIPTION OF THE EXEMPLARY EMBODIMENTS

In the following, a device and a system for implementing the method for joining two components of a unit to be screwed together are described. Here, the same reference numbers designate the same or similar elements in the respective figures.

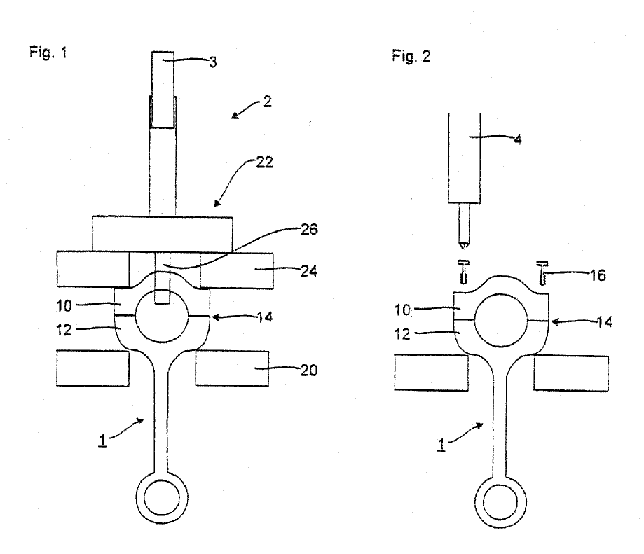

In FIGS. 1 and 2, a unit 1 in the form of a broken connecting rod is respectively shown. The broken connecting rod 1 comprises a top 10 and a shaft 12 which are separated from one another at the separation surface 14 by fracturing. By joining the top 10 to the shaft 12 at the separation surface 14 the broken connecting rod 1 can be put together again and be brought into its functional configuration.

The top 10 and the shaft 12 of the broken connecting rod I are typically joined permanently here by screwing together.

In FIG. 1 the step is shown of joining the components which are later to be screwed together, namely the top 10 and the shaft 12 of the unit, by means of a joining device 2.

The joining device 2 comprises a retainer 20 in which the shaft 12 of the broken connecting rod 1 is held securely. The top 10 of the broken connecting rod 1 is pressed by means of a pressing device 22 onto the shaft 12. A retainer 24 is provided here which guides the top 10. The pressing device 22 can exert a joining force here in the direction of the shaft 12 of the broken connecting rod I and can also lift the top 10 from the shaft 12 by means of a gripper 26. In this way, the two components can also be separated from one another again in order to clean the respective joining surfaces or separation surfaces.

A hydraulic cylinder or pneumatic cylinder 3 applies the required joining force to the pressing device 22 here.

Applying a correspondingly high joining force by means of the hydraulic cylinder 3 via the retainer 24 onto the top 10 which is pressed onto the shaft 12 held in the retainer 20, i.e. applying a joining force to the separation surface 14, leads to fixing procedures being initiated in the separation surface 14.

Since the pressing device 22 is independent of the screwing and yield properties of screws, a force can be applied to the separation surface 14 which is greater than the force which could be exerted upon the separation surface 14 purely by screwing together the two components 10, 12. In particular, it is possible by using the hydraulic cylinder 3 to apply substantially greater joining forces or surface pressures upon the separation surface 14 than would be possible by screwing together using conventional screws.

Therefore, the screws which are later to connect the two components 10, 12 of the unit 1 can be saved for this first joining procedure, and in particular for initiating the corresponding fixing procedure in the separation surface 14.

After the first joining, the two components 10, 12 are separated from one another again in the example shown in FIG. 1 by moving the pressing device 22 contrary to the direction of the shaft 12, i.e. in order to lift the top 10 from the shaft 12.

After opening, the two separation surfaces 14, which are now exposed, can be cleansed of any particles, impurities, inclusions or other foreign bodies located in this region by shaking the components against one another, by blowing out, brushing away, by fluid treatment or by other mechanical procedures.

By means of the fixing procedure and the joining procedure, particles, for example, which have, been bent off in the fracture, but which are still securely connected to the separation surface, can be detached by correspondingly bending back the separation surface. In this way, such particles and foreign bodies in the separation surface can also be detached and then removed.

In connection with this it should be mentioned that there is the possibility of recording the joining force applied to the separation surface 14 by the pressing device 22 over the joining path, i.e. to record a joining force/path characteristic curve for the joining procedure. From this joining force/path characteristic curve it can then be determined by comparing with a reference family of characteristics whether there are foreign bodies, in particular particles, inclusions or other impurities on the separation surface 14.

In particular, when there is such a particle, the joining force/path characteristic curve extends differently than with a totally clean separation surface. When there is a particle, the joining force/path characteristic curve, particularly in the lower region, is flatter because the particle is less rigid than the joining surface as a whole. Accordingly, by means of this calculation it can be determined whether there is a foreign body on the joining surface 14. If with this evaluation this type of foreign body can be determined, in the following procedure of re-separating the components one can ensure that this particle is removed. In order to be sure, the joining procedure can be repeated by means of the joining press.

Furthermore, it is possible to vary the joining force applied, to the separation surface 14 by means of the hydraulic cylinder 3. In particular, it is possible to vary the joining force such that the fixing procedures in the separation surface 14 are ideally assisted. For this purpose it is conceivable, for example, to apply the joining force to the separation surface 14 sinusoidally, in the form of an impulse or according to some other specific scheme.

After separating the components, the components 10, 12 are re-joined. Here the components 10, 12 are joined to one another by screwing together by means of the screws 16 provided for this purpose so as then to be brought into the respective fitted position, for example for fitting into an engine and for connecting to the corresponding crank shaft.

In this step, the components 10. 12 joined correspondingly by screwing together with the screws 16 provided for this purpose which are driven into the unit 1 by means of a screwdriver 4. The screws 16 are only stressed here as required in order to join together the two components 10, 12 securely (for transport).

However, upon the basis of the present method it is no longer necessary to apply such a high joining force to the separation surface 14 via the screws 16 such that fixing procedures on the separation surface 14 are initiated, or that any possibly present foreign bodies are detached. When joining by screwing together in this work station it is only ensured that the two components are joined together such that the unit can be conveyed safely to the fitting position without being damaged or parts going missing.

1. A method for joining two components (10, 12) of a unit (1), especially a fractured unit, to be screwed together, comprising the steps:
first joining of the components by means of a joining device (2), especially a joining press (22);
separating the components; and
re-joining the components by screwing them together.

2. The method according to claim 1, the joining device applying a joining force or a surface pressure to the joining surface (14).

3. The method according to claim 2, the joining device applying to the components on the joining surface a joining force or surface pressure which is greater than the joining force or surface pressure which can be achieved by screwing together.

4. The method according to any of the preceding claims, after separating the components the joining surface, in particular the separation surface., being cleansed of foreign bodies, in particular of particles, inclusions or other impurities, in particular by shaking, brushing, fluid treatment, blowing off, manual removal or other appropriate steps.

5. The method according to any of the preceding claims, the joining force or the surface pressure being varied during joining in the joining device, in particular in order to accelerate fixing procedures in the joining surface.

6. The method according to any of the preceding claims, the components being the top (10) and the shaft (12) of a broken connecting rod (1) or the top and the lower part of a universal joint yoke.

7. The method according to any of the preceding claims, wherein during joining with the joining device, a joining force/path characteristic curve being recorded, the characteristic curve being compared to a family of reference characteristics, and the presence of a foreign body on the separation surface being specified if the joining force/path characteristic curve measured deviates from the family of reference characteristics.

8. The method according to claim 7 when there is an impurity on the joining surface after separating e components, the joining procedure being repeated with the joining device.

9. A joining system for implementing according any e preceding claims, comprising
a joining device (2) for applying a joining force or a surface pressure to the joining surface between the two components of the unit;
a separating device for separating the two components; and
a screwing device for screwing the two components together.

10. The joining system according to claim 9, the joining device and the separating device being integrated with one another, and especially in the form of a device that can move at least one of the two components, which can apply a corresponding joining force or surface pressure to the joining surface simultaneously.
